(19) United States
(12) Patent Application Publication
(10) Pub. No.: US 2016/0210695 A1
(43) Pub. Date: Jul. 21, 2016

(54) Computer-Implemented Asset Allocation Method

(71) Applicant: Active Asset Allocation, Nice (FR)

(72) Inventor: Ardina Grigoriu, Nice (FR)

(21) Appl. No.: 14/597,794

(22) Filed: Jan. 15, 2015

(51) Int. Cl. G06Q 40/06

(52) U.S. Cl. CPC G06Q 40/06

(57) ABSTRACT

The invention relates to a computer-implemented asset allocation method configured to allocate assets of at least one participant to a saving program comprising N portfolios respectively presenting a maximum loss level, comprising a step of sorting the N portfolios according to their respective maximum loss level, a step of calculating a gain of each of the N portfolios at the end of an inter-transfer period, and an automatic gain allocation step, performed at the end of the inter-transfer period or at the beginning of a next inter-transfer period when the gain of the portfolio is greater than a predetermined value, consisting of transferring the gain of the portfolio to another portfolio which presents either the greatest maximum loss level among portfolios with a smaller maximum loss level than that of the portfolio deriving the gain, either the smallest maximum loss level among portfolios with a greater maximum loss level than that of the portfolio deriving the gain.

### TECHNICAL FIELD

The present invention relates generally to an asset allocation method and, more particularly an asset allocation method configured to automatically distribute assets among a plurality of portfolios while keeping losses no greater than a pre-determined maximum level.

### BACKGROUND

In general, retirement plans can be classified into two categories: defined benefit (DB) plans or defined contribution (DC) plans.

A DB plan pays retirees a benefit based on years of service and salary level until they die. Throughout the course of an employee’ working life contributions are regularly invested in an investment fund. However, there is no guarantee that the DB plan will be sufficiently funded to meet its payment obligations since the future return of the investment fund remains always unknown in advance. It is therefore the responsibility of the sponsor (e.g. the employer) to guarantee that retirees will receive their promised pensions. Investment risks are typically assumed by the sponsor and not by the individual in this type of schemes. Due to this reason, less and less employers are ready to assume the significant costs associated with the sponsor risks and prefer putting more investment risk on the shoulders of employees.

On the contrary, in a DC plan arrangement, it is the employee's responsibility to manage his/her own investments. Regularly the company sets aside a certain amount of money for the benefit of the employee, who is offered a choice of third-party managed investment vehicles to invest his/her contributions in.

To overcome the employees' lack of financial expertise and offer him simplicity, several pre-packaged investment programs, such as target-date funds, are proposed in the early 1990s. Target-date funds are increasingly popular due to the auto-enrollment regulations that encourage DC plan members to adopt them by default. In such funds, the asset allocation follows a glidepath. It is a deterministic function of years, and it becomes increasingly conservative as the program's target date approaches. The time-dependent asset-mix is predetermined using assumptions on the future risk-return profile of the assets being used.

Therefore those target date funds generally lack of flexibility and reactivity to the financial markets. Moreover, it does not exist a promising way for the employee to know the lower bound of the amount of the pension that he will obtain when he is retired. Indeed the maximum loss of the target date funds is difficult to predict, especially when no efficient risk-management method is applied to his/her investment vehicle. Ex-post, for example, it appeared that most of 2050-maturing target date funds that have been marketed before 2008 by the major asset management firms have suffered losses exceeding 50% from peak to valley.

In general, the employees would prefer participate a retirement saving program that can provide these future retirees with an incremental risk protection as the age of the participant increases. In other words, the investment process should be such that the closer the saving program participant is to retire, the less he/she could possibly lose. The participants may also wish to limit their losses to a predefined maximum level.

A well-known investment concept “Proportion Portfolio Insurance (PPI)”, provides numerous advantages such as adapting an investment portfolio's exposure to market conditions and helping limit the portfolio's loss during market downturns while still permitting to gain exposure to market rallies (which is referred to as “asymmetric risk exposure”).

However, nowadays a saving program generally comprises a set of investment portfolios. Even applying the PPI model to each of the investment portfolios of the saving program, it does not specially allow one to de-risk his/her portfolio when getting close to retirement, since the adjustment of risk protection is performed in an individual and independent manner for each of the portfolios of the saving program.

Therefore, the objective of the present invention is to provide an asset allocation method for automatically allocating, during the life of the saving program, assets to portfolios of the saving program while providing a great flexibility and reactivity to different market conditions and an adjustable downside risk protection for the invested assets of the saving program.

A technical aim of the invention is to reduce computing resources during the asset allocation stages, through an automated process.

### SUMMARY

The invention relates to a computer-implemented asset allocation method configured to allocate assets of at least one participant to a saving program comprising N portfolios, the life of the saving program comprising T inter-transfer periods, T being a positive integer, each of the N portfolios comprising assets, presenting a portfolio value and a maximum loss level, the latter being configured to indicate the maximum possible percentage that the portfolio value may lose.

Said computer-implemented asset allocation method comprises a step of sorting the N portfolios according to their respective maximum loss level, the N sorted portfolios being indexed by a positive integer n between 1 and N, so as to indicate that a first portfolio (with n being 1) presents the smallest maximum loss level among the N portfolios, and the maximum loss level of a n-th portfolio among the N portfolios is not smaller than the maximum loss level of a (n−1)th portfolio when n is between 2 and N; a step of calculating a gain for each of the N portfolios at the end of a (m−1)th inter-transfer period (wherein m is a positive integer between 2 and T), a gain of a n-th portfolio=a final portfolio value—an initial portfolio value, wherein the final portfolio value of assets of the n-th portfolio is obtained at the end of the (m−1)th transfer period, and the initial portfolio value of assets in the n-th portfolio is obtained at the beginning of the (m−1)th inter-transfer period; and an automatic gain allocation step performed so that the initial portfolio value of the (n−1)th or (n+1)th portfolio obtained at the beginning of the m-th inter-transfer period comprises the gain of the n-th portfolio. Said automatic gain allocation step consists of, for each of the N portfolios, transferring the gain of the n-th portfolio obtained at the end of the (m−1)th inter-transfer period to (a) the (n−1)th portfolio for the m-th inter-transfer period if said gain is greater than a first predetermined value, wherein the gain of the first portfolio for the (m−1)th inter-transfer period is remained in the first portfolio for the m-th inter-transfer period, or (b) the (n+1)th portfolio for the m-th inter-transfer period if said gain is greater than the first predetermined value, wherein the gain of the N-th portfolio for the (m−1)th inter-transfer period is remained in the N-th portfolio for the m-th inter-transfer period.

Another aspect of the invention concerns an asset allocation system comprising a computerized system comprising a non-transitory computer-readable medium and a processor. The non-transitory computer-readable medium is configured to store at least (a) a computer program configured to allocate assets of at least one participant to a saving program comprising N portfolios, the life of the saving program comprising T inter-transfer periods, T being a positive integer, and (b) data of each of the N portfolios, for each of the T inter-transfer periods, comprising assets presenting a portfolio value and a maximum loss level, the latter being configured to indicate the maximum possible percentage that the portfolio value may lose.

Said processor is configured to execute, in accordance with the computer program stored in the non-transitory computer-readable medium, instructions for [a] sorting the N portfolios according to their respective maximum loss level, the N sorted portfolios being indexed by a positive integer n between 1 and N, so as to indicate that a first portfolio (with n being 1) presents the smallest maximum loss level among the N portfolios, and the maximum loss level of a n-th portfolio among the N portfolios is not smaller than the maximum loss level of a (n−1)th portfolio when n is between 2 and N, [b] calculating a gain for each of the N portfolios at the end of a (m−1)th inter-transfer period (wherein m is a positive integer between 2 and T), a gain of a n-th portfolio=a final portfolio value—an initial portfolio value, wherein the final portfolio value of assets of the n-th portfolio is obtained at the end of the (m−1)th inter-transfer period, and the initial portfolio value of assets in the n-th portfolio is obtained at the beginning of the (m−1)th inter-transfer period, and [c] performing an automatic gain allocation step so that the initial portfolio value of the (n−1)th or (n+1)th portfolio obtained at the beginning of the m-th inter-transfer period comprises the gain of the n-th portfolio. Said automatic gain allocation step consists of, for each of the N portfolios, transferring the gain of the n-th portfolio obtained at the end of the (m−1)th inter-transfer period to <a> the (n−1)th portfolio for the m-th inter-transfer period if said gain is greater than a first predetermined value, wherein the gain of the first portfolio for the (m−1)th inter-transfer period is remained in the first portfolio for the m-th inter-transfer period, or <b> the (n+1)th portfolio for the m-th inter-transfer period if said gain is greater than the first predetermined value, wherein the gain of the N-th portfolio for the (m−1)th inter-transfer period is remained in the N-th portfolio for the m-th inter-transfer period.

Therefore, the present invention allows to automatically allocate, during the life of the saving program, assets to portfolios of the saving program while providing a great flexibility and reactivity to different market conditions and an adjustable downside risk protection for the invested assets of the saving program. The allocation of gains deriving from assets is automatic and its configuration is preferably determined at the very beginning of the process, so that computation efficiency can be significantly improved and/or less computer resources are required during the investment period.

### BRIEF DESCRIPTION OF THE DRAWINGS

The foregoing and other aspects of the embodiments of the present invention are made more evident in the following Detailed Description, when read in conjunction with the attached Figures, wherein:

FIG. 1 gives an example of a functional block diagram of an asset allocation system 1 according to an embodiment of the invention.

FIG. 2 shows a portfolio X divided into two components, one riskier than the other, according to an embodiment of the invention

FIG. 3 illustrates two directions of the chain transfer according to the invention.

FIG. 4(a) is an example of the distribution of assets of the saving program with a yearly deposit allocated to the riskiest portfolio according to the Invention. FIG. 4(b) shows, on the other hand, an example of the distribution of assets of the saving program with only one single deposit allocated to the riskiest portfolio according to the invention.

FIG. 5 is an example of the evolution of the portfolio value of a portfolio of the saving program protected by a floor value according to the invention.

### DETAILED DESCRIPTION

Before the introduction of the present invention, certain terms used in the following description are defined as follows:
Deposit: movement of an amount of money that is added to a saving program
Portfolio: a saving program generally comprises a plurality of portfolios, each of which is constructed by combining assets allocated in components with different expected rates of return and different risk levels (maximum loss levels). The whole saving program allows a participant to allocate his/her assets in the portfolios to achieve a maximum expected rate of investment return consistent with his/her tolerance for risk.
Distribution: allocation of the participant's assets in the portfolios included in the saving program.
Return of a portfolio:
(a) Change in the portfolio's value since the last evaluation period, consisting of capital appreciation/depreciation of the securities included in the portfolio. It is usually expressed as a percentage of the portfolio's net assets.
(b) (a) and including the income generated by the securities held in the portfolio (coupons, dividends . . . ).
(c) (a) and (b) minus costs involved in the management of the portfolio (transaction costs, management fees, advisory fees, over-performance fees, taxes, etc.).
Gain: If a portfolio yielded a positive return, the gain is the corresponding increase in the portfolio's assets value. It is expressed as an amount in a given currency.
Maximum drawdown: The maximum drawdown is a financial risk measure. It represents the loss that an investor would have suffered during a specific period, had he bought at the highest point and sold at the lowest.
Floor: For a given portfolio of the saving program, it is a theoretical value representing at any point in time the level under which the portfolio's value should not fall.
Cushion: A cushion is equal to the distance between a portfolio's value and its floor.
Rebalancing: In a given portfolio, rebalancing corresponds to the action of changing the allocation of assets in the portfolio.
Transfer: Movement of an amount of money from a portfolio of the saving program to another portfolio of the saving program. Transfers impact the distribution of assets of the participant among the different portfolios.

Exemplary embodiments of the invention are summarized hereafter; they can each be used independently or in combination with at least another exemplary embodiment of the invention:
A set of steps of allocating assets in the n-th portfolio, the n-th portfolio comprising at least two components comprising a first component and a second component, wherein the risk level of the second component is greater than that of the first component, the set of steps of allocating assets comprising:
   calculating, for the n-th portfolio, a cushion value C %=(the current portfolio value CPV of the n-th portfolio−the floor value of the n-th portfolio)/said portfolio value CPV,
   allocating X % of the initial portfolio value of the n-th portfolio to the second component, wherein X=M*C,
   allocating Y % of said current portfolio value CPV of the n-th portfolio to the first component, wherein Y=100−X,
wherein a floor value of the n-th portfolio is configured to indicate that the portfolio value CPV of the n-th portfolio obtained at any time point needs to be not smaller than the floor value, and the multiplier M of the n-th portfolio is a coefficient configured to adjust the sensibility of the n-th portfolio to market changes.
The set of steps of allocating assets comprising, prior to the step of calculating the cushion value C % of the n-th portfolio, a step of defining the floor value and/or a step of defining the multiplier M.
The set of steps of allocating assets in the n-th portfolio are triggered if one of the following rebalancing conditions (a) to (d) is satisfied:
   (a) the portfolio value CPV of the n-th portfolio is smaller than a corresponding predetermined minimum value;
   (b) the portfolio value CPV of the n-th portfolio is greater than a corresponding threshold value;
   (c) the relative proportion between the assets allocated in the first and second components of the n-th portfolio deviates from a previously determined target proportion more than a pro-specified level determined as a function of the target proportion;
   (d) periodical rebalancing, performed according to a rebalancing frequency pre-defined by the participant.
The predetermined minimum value is determined as a function of the floor value of the n-th portfolio.
The predetermined minimum value is 101% of the floor value.
The predetermined threshold value is determined as a function of the floor value of the n-th portfolio.
The predetermined threshold value is 105% of the floor value.
The predetermined threshold value is greater than the predetermined minimum value.
A set of steps of allocating assets in at least one component of the first and second components of the n-th portfolio, the component comprising at least two sub-components comprising a first sub-component and a second sub-component, wherein the risk level of the second sub-component is greater than that of the first sub-component, the set of steps of allocating assets in the component comprising:
   allocating X % of the component value of the component to the second sub-component, wherein the component value is obtained at a time point of the m-th inter-transfer period,
   allocating Y % of said component value.
The set of steps of allocating assets in at least one component is preferably performed recursively.
If the gain of the n-th portfolio obtained at the end of the (m−1)th inter-transfer period is not greater than the first predetermined value, assets in the n-th portfolio will be remained for the m-th inter-transfer period.
A step of allocating a new deposit to the saving program for the m-th inter-transfer period (m≧1), configured so that the initial portfolio value of at least one of the N portfolios obtained at the beginning of the m-th inter-transfer period comprises at least a part of said new deposit.
at least one of the following deposit allocation rules (a) to (e) performed to allocate a new deposit to at least one of the N portfolios for the m-th inter-transfer period:
   (a) the new deposit is entirely allocated to a pre-selected portfolio of the saving program for the m-th inter-transfer period;
   (b) the new deposit is equally allocated to the N portfolios for the m-th inter-transfer period;
   (c) the new deposit is equally allocated to several pre-selected portfolios among the N portfolios for the m-th inter-transfer period;
   (d) the new deposit is non-equally allocated to the N portfolios for the m-th inter-transfer period;
   (e) the new deposit is non-equally allocated to several pre-selected portfolios among the N portfolios for the m-th inter-transfer period, wherein the pre-selected portfolios are chosen by the participant as well as the amounts of capital received by the pre-selected portfolios.
At least one of the pre-selected portfolio, the plurality of pre-selected portfolios, the amounts of capital received by the plurality of pre-selected portfolios of the deposit allocation rule (e), the proportions of capital received by the N portfolios of the deposit allocation rule (d) is pre-defined by the participant.
The pre-selected portfolio is determined as a function of time.
Any two of the N portfolios present a different maximum loss level.
The first portfolio presents a smallest maximum loss level equal to 0%.
A step of transferring at least a part of assets in at least one of portfolios of the saving program other than the first portfolio to the first portfolio with a maximum loss level equal to 0%.
A computer program product is stored in non-transitory computer-readable medium and comprises instructions adapted to perform the computer-implemented asset allocation method of the invention.

It should be noted that some of the features of the exemplary embodiments of the present invention may be used to advantage without the corresponding use of other features. As such, the foregoing description should be considered as merely illustrative of the principles, teachings and embodiments of this invention, and not in limitation thereof.

The following description is provided by way of exemplary and non-limiting examples a full and informative description of various method, apparatus and computer program software for implementing the exemplary embodiments of this invention. However, various modifications and adaptations may become apparent to those skilled in the relevant arts in view of the foregoing description, when read in conjunction with the accompanying drawings and the appended claims. As but some examples, the use of other similar or equivalent processes or algorithms and data representations may be attempted by those skilled in the art. Further, the various names used for the different elements, functions and algorithms are merely descriptive and are not intended to be read in a limiting sense, as these various elements, functions and algorithms can be referred to by any suitable names. All such and similar modifications of the teachings of this invention will still fall within the scope of the embodiments of this invention.

Embodiments of the various techniques described herein may be implemented in digital electronic circuitry, or in computer hardware, firmware, software, or in combinations of them. Embodiments may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data. e.g., magnetic, magneto optical disks, or optical disks.

FIG. 1 gives an example of a functional block diagram of an asset allocation system 1 according to an embodiment of the invention. The asset allocation system 1 is configured to execute a computer-implemented asset allocation method configured to allocate assets to a saving program. The following exemplary embodiments encompass a non-transitory computer-readable medium that contains software program instructions, where execution of the software program instructions by at least one data processor results in performance of operations that comprise execution of the method of the present invention.

The saving program comprises a number N of portfolios. The number N is a positive integer preferably greater than 1. The asset allocation system 1 comprises an input device 3, an output device 16, an external database 4 and a computer system 2 which is coupled to the input device 3, the output device 16 and the external database 4.

The computer system 2 comprises a processor and a data storage means 5. The processor is utilized for executing rules and steps of the asset allocation method for allocating assets of at least one participant among the N portfolios in order to yield, directly or indirectly, positive gains from the assets invested in the N portfolios. The rules and steps of the asset allocation method will be illustrated in detail in the following paragraph.

The data storage means 5 is utilized for storing data that may be derived or transferred to the computer system 2 from the external database 4 and/or from the input device 3. The storage means 5 is advantageously utilized for storing the above mentioned rules and parameters 6 of the saving program, information 7 of the at least one participant of the saving program, data 8 of each of the N portfolios, aggregated data 9 produced during the execution of the saving program, and financial data 10. The rules of the asset allocation method and the parameters of the saving program will be presented in detailed in the following paragraphs.

The information 7 comprises, for example, historical distributions of the participant's assets that are previously allocated to the portfolios during the past inter-transfer periods, such as the amount of deposits previously invested by the participant to the portfolios. The data 8 of each of the N portfolios comprises, for example, data necessary for the asset allocation system 1 to follow-up and rebalance each of the N portfolios of the saving program, such as one portfolio's asset allocation, the level of the protection floor, value of the multiplier M, etc. The data 8 will be described in detail in the following paragraphs. The aggregated data 9 provides the participant with information comprising at least the overall asset allocation of the saving program, and a maximum loss level of the saving program indicating the possible maximum loss that the participant may possibly suffer.

The financial data 10 comprises, for instance, the portfolio value of the assets allocated in the N portfolios and other financial data that is necessary to follow-up and rebalance the saving program's N portfolios.

The input device 3, comprising preferably a keyboard and a video monitor, is utilized for allowing the user of the asset allocation system 1, such as the administrator who manages the saving program, to input data to the asset allocation system 1. Other input means providing the above function can be implemented in another embodiment of the invention.

As mentioned above, the processor of the computer system 2 is utilized for executing the rules and steps of the asset allocation method for allocating assets among the N portfolios of the saving program. In a preferred embodiment, the processor is utilized for implementing a system manager 15 and an asset allocation module 11 in order to perform properly the rules of the asset allocation method. The asset allocation module 11 comprises a capital distribution module 12, a portfolio asset allocation module 13 and an aggregation module 14.

The system manager 15 is configured to receive data from the data storage means 5 and send instructions to the asset allocation module 11 for allocating assets of the at least one participant among the N portfolios of the saving program. For ease of comprehension, the asset allocation method and system of the invention will be illustrated in detail by describing how to allocate assets of one participant of the saving program, to the N portfolios. However, the invention is not limited to the number of participants of the saving program. In another embodiment of the invention, the asset allocation method and system of the invention is utilized for allocating assets of a plurality of participants of the saving program. The present invention is also capable of being applied to any individual or pooled financial saving program such as defined contributions investment plans or target date fund programs available to individuals or groups, corporates entities or institutions.

In addition, the life of the saving program comprises a total number T of inter-transfer periods, wherein T is a positive integer, preferably greater than 1. The value of T and the length of an inter-transfer period (e.g. one year or 18 months, etc) are respectively predetermined by the participant. Each of the T inter-transfer periods corresponds to a distribution of the participant's assets among the N portfolios.

In an embodiment of the invention, the life of the saving program is finite and thus comprises a given target date (or “maturity date”). In another embodiment of the invention, the saving program is not designated to end at a given target date and T can thus be an infinite positive integer. In the latter case, the saving program continues to function until the participant decides to interrupt it. The present invention is not limited to the length of the life of the saving program.

Each of the N portfolios comprises assets and presents a portfolio value CPV and a maximum loss level, the latter being configured to indicate the maximum possible percentage that the portfolio value may lose. In a preferred embodiment, any two of the N portfolios present a different maximum loss level.

The system manager 15 is configured to execute a rule of the asset allocation method of the invention—a step of sorting of the N portfolios according to their respective maximum loss level, the N sorted portfolios being then indexed by a positive integer number n in order to indicate that the maximum loss level of a (n+1)th portfolio is not smaller than the maximum loss level of a n-th portfolio. In other words, the greater the value of n is, the greater maximum loss level of the corresponding portfolio presents. Thus, a first portfolio (with the value of n being 1) is the safest portfolio of the saving program since it presents the smallest maximum loss level among the N portfolios of the saving program. The second portfolio (with the value of n being 2) presents the second smallest maximum loss level among the N portfolios. The N-th portfolio (with the value of n being N) is the riskiest portfolio of the saving program since it presents the greatest maximum loss level among the N portfolios.

In a preferred but not limitative embodiment, the first portfolio of the saving program presents a maximum loss level equal to 0%. In this example, a money market fund with a zero-maximum loss is chosen to be the first portfolio.

The asset allocation method of the invention comprises a deposit allocation policy that is preferably predefined by the participant and stored in the internal data storage means 5 or the external database 4.

Before a m-th inter-transfer period of the saving program begins, the system manager 15 is configured to retrieve the deposit allocation policy and then sends instructions generated according to the retrieved deposit allocation policy to the capital distribution module 12 of the asset allocation module 11. m is a positive integer, wherein m=1, 2, 3, . . . T.

The deposit allocation policy predefined by the participant describes several aspects, such as the amount of capital and the way of payment, of allocating a new deposit to at least one of the N portfolios for the m-th inter-transfer period. The new deposit that will be invested in one of the N portfolios is not smaller than 0 and different from the existing assets in any of the N portfolios.

More precisely, the deposit allocation policy comprises the following rules (a) to (c) of payment of a new deposit to the saving program for the m-th inter-transfer period:
(a) An initial lump sum—the total amount of the new deposit paid in one single payment effected at the beginning of the first inter-transfer period of the saving program (wherein m=1).
(b) Periodical payments of a fixed or variable amount—the total amount of the new deposit being divided into several periodical payments, wherein the amounts of capital of the periodical payments can be identical or different.
(c) Arbitrary payments—the total amount of the new deposit being divided into several sub-payments which are effected in different time intervals pre-defined by the participant, wherein the amounts of capital of the sub-payments can be identical or different.

Furthermore, the deposit allocation policy comprises preferably at least one of the following deposit allocation rules (a) to (e) performed to allocate a new deposit to at least one of the N portfolios for the m-th inter-transfer period:
(a) The new deposit is entirely allocated to a pre-selected portfolio of the saving program for the m-th inter-transfer period. The participant may select the N-th portfolio presenting the greatest maximum loss level or the first portfolio presenting the smallest maximum loss level, as the pre-selected portfolio designated to receive the full amount of the new deposit for the m-th inter-transfer period. The pre-selected portfolios of different inter-transfer periods of the saving program may be identical or different, depending on the participant's investment consideration. Advantageously, the pre-selected portfolios of different inter-transfer periods of the saving program are assigned in a time-dependent manner. For example, the riskiest portfolio among the N portfolios is determined to be the pre-selected portfolio when the m-th inter-transfer period is one the first five inter-transfer periods, and the safest portfolio among the N portfolios is determined to be the pre-selected portfolio when the m-th inter-transfer period is not one the first five inter-transfer periods.
(b) The new deposit is equally allocated to the N portfolios for the m-th inter-transfer period.
(c) The new deposit is equally allocated to several pre-selected portfolios among the N portfolios for the m-th inter-transfer period, wherein the pre-selected portfolios are chosen by the participant.
(d) The new deposit is non-equally allocated to the N portfolios for the m-th inter-transfer period, wherein the proportions of capital received by the N portfolios are pre-defined by the participant.
(e) The new deposit is non-equally allocated to several pre-selected portfolios among the N portfolios for the m-th inter-transfer period, wherein the pre-selected portfolios are chosen by the participant as well as the amounts of capital received by the pre-selected portfolios are pre-defined by the participant.

The asset allocation method of the invention comprises thus preferably the deposit allocation policy comprising one or a combination of the deposit allocation rules that are preferably predefined and/or pre-selected by the participant and stored in the internal data storage means 5 or the external database 4.

The invention is not limited to the above-mentioned deposit allocation rules. In another embodiment of the invention, a participant of the saving program can predefine different deposit allocation rules to determine the way to allocate a new deposit to at least one of the N portfolios of the saving program for a m-th inter-transfer period, the amount of the capital of the new deposit and the payment of the new deposit.

Therefore, as mentioned above, the system manager 15 generates instructions according to the retrieved deposit allocation rules of the deposit allocation policy and sends the instructions to the capital distribution module 12. The capital distribution module 12 allocates, according to the instructions sent by the system manager 15, the new deposit to at least one of the N portfolios at the beginning of the m-th inter-transfer period. The at least one of the N portfolios, pre-selected by the participant, presents thus an initial portfolio value comprising at least a part of the new deposit. For example, in a case with the value of m being 1, which means the saving program is in its first inter-transfer period, each of the pre-selected portfolios presents an initial portfolio value equal to the received amount of a part of the new deposit. The initial portfolio value of each of the rest of the N portfolios is equal to 0.

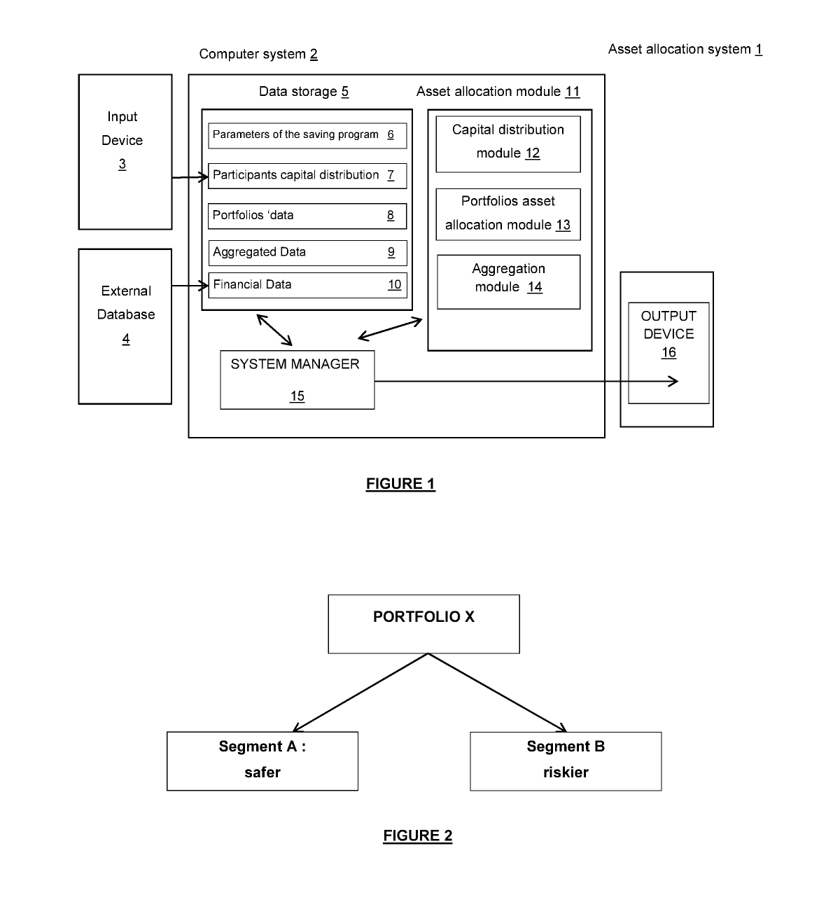

In a preferable embodiment, at least one of the N portfolios, such as a n-th portfolio, comprises at least two components with different risk levels. Advantageously, the n-th portfolio comprises a first component and a second component wherein the risk level of the second component is greater than that of the first component, as illustrated in FIG. 2. FIG. 2 shows a portfolio X divided into two components, one riskier than the other, according to an embodiment of the invention. The allocation between the two segments is periodically and/or dynamically adjusted, which will be illustrated in the following paragraphs.

The assets allocated to the first component are invested in safer assets classes, for example, money market funds or bonds. The assets allocated to the second component are invested in riskier assets classes such as equities or commodities.

The asset allocation method of the invention comprises preferably a set of steps 203 to 205 of allocating assets in at least one of the N portfolios in order to assign or change the proportions of assets respectively allocated in the first and second components of the n-th portfolio. Preferably, the system manager 15 and/or the portfolio asset allocation module 13 are configured to execute the set of steps 203 to 205 to dynamically or periodically adjust asset allocation among components of one of the N portfolios (such as the n-th portfolio) when one of following rebalancing conditions (a) to (d) preferably predefined by the participant is satisfied:
(a) Dynamical rebalancing depending on the portfolio value:
   The portfolio value of the n-th portfolio (n=1, 2, 3 . . . N) is smaller than a corresponding predetermined minimum value predefined by the participant, wherein the N portfolios may have identical or different predetermined minimum value;
(b) Dynamical rebalancing depending on the portfolio value:
   The portfolio value of the n-th portfolio (n=1, 2, 3 . . . N) is greater than a corresponding threshold value predefined by the participant, wherein the N portfolios may have identical or different threshold value;
(c) Dynamical rebalancing depending on the proportions of assets allocated in the components of the n-th portfolio:
   The relative proportion between the assets allocated in the first and second components of the n-th portfolio deviates from a previously determined target proportion more than a pre-specified level determined as a function of the target proportion. The pre-specified level indicates the tolerance level of deviation from the target proportion and can be expressed as a percentage value. In addition, said deviation may be caused by the changes in asset prices for Instance.
   For example, according to the previously determined value of the n-th portfolio, the target proportion between the assets allocated in the first and second components of the n-th portfolio should be 50%/50%. However, within a certain period of time (e.g. one month), the price of the first asset is decreased while the price of the second asset is increased. The current relative proportion between the assets allocated in the first and second components of the n-th portfolio is for example 49%/51% instead of 50%/50% and thus deviates of 1% away from the target proportion. The pre-specified level is 5%. When the relative proportion deviated from the target proportion by 5%, the set of steps 203 to 205 and/or the steps 201, 202 of allocating assets are triggered to be executed;
(d) Periodical rebalancing, performed according to a rebalancing frequency preferably pre-defined by the participant; for example, at the beginning of each inter-transfer period of the saving program.

The asset allocation method of the invention comprises thus preferably a rebalancing execution policy comprising one or a combination of the rebalancing conditions (a) to (d) that are preferably predefined and/or reselected by the participant and stored in the internal data storage means 5 or the external database 4.

The invention is nevertheless not limited to the above-mentioned rebalancing conditions. Other rebalancing conditions might be able to be included in the rebalancing execution policy by the participant.

In a preferred embodiment, the above-mentioned predetermined minimum value of the n-th portfolio is determined as a function of the floor value of the n-th portfolio. For example, the predetermined minimum value is 101% of the floor value.

In a preferred embodiment, the above-mentioned predetermined threshold value of the n-th portfolio is determined as a function of the floor value of the n-th portfolio. For example, the predetermined threshold value is 105% of the floor value.

Advantageously, the threshold value of the n-th portfolio is greater than the predetermined minimum value of the n-th portfolio.

When one of the rebalancing conditions (a) to (d) is satisfied, for example, at the beginning of a m-th inter-transfer period (e.g. the condition (d)), the steps 203 to 205 of allocating assets in the n-th portfolio of the saving program is triggered. The system manager 15 retrieves data and information stored in the data storage means 5 and, prior to the execution of the step 203 of calculating a cushion value C % for the n-th portfolio, the system manager 15 performs advantageously a step 201 of defining a floor value configured to indicate that the portfolio value of the n-th portfolio obtained at any time point needs to be not smaller than the floor value. The floor value of the n-th portfolio is preferably expressed in the same unit as the n-th portfolio's value. In a preferred embodiment, the floor value of the n-th portfolio can be adjusted throughout the life of the n-th portfolio to meet specific objectives, for instance, preventing the portfolio value of the n-th portfolio's from falling below 10% of the maximum it has reached in the past.

The system manager 15 is also configured to perform a step 202 of defining a multiplier M for the n-th portfolio. The multiplier M is applied to multiply the cushion value C % (illustrated in the following paragraphs) to obtain exposure to the risky asset and to make the n-th portfolio more or less sensitive to the market changes. Also, since increasing the value of the multiplier M increases the probability that the n-th portfolio breaches its floor value, the value of multiplier M needs to be carefully determined.

In an embodiment, the multiplier M is a fixed number between 0 and 30 and preferably determined at the beginning of the saving program. In another embodiment, the multiplier M is a variable number which may change according to a function pre-defined by the participant. In a preferable but not limitative embodiment, the value of the multiplier M is between 0 and 30.

The system manager 15 then performs the step 203 of calculating, for the n-th portfolio, a cushion value C % which is obtained by performing the following equation:

Cushion value C %=(the current portfolio value CPV of the n-th portfolio−the floor value of the n-th portfolio)/said current portfolio value CPV.

The cushion value C % may vary if the portfolio value CPV of the n-th portfolio obtained at another time point changes.

In a preferred embodiment, the system manager 15 sends the floor value, the multiplier M, the portfolio value CPV and the cushion value C % of the n-th portfolio to the portfolio asset allocation module 13. The portfolio asset allocation module 13 is configured to perform a step 204 of allocating X % of the current portfolio value CPV of the n-th portfolio to the second component, wherein X=M*C, The portfolio asset allocation module 13 is also configured to perform a step 205 of allocating Y % of said portfolio value CPV to the first component, wherein Y=100−X. In another embodiment, the values of the above-mentioned X and Y can be calculated by the system manager 15 and sent to the portfolio asset allocation module 13.

In an example where the portfolio value CPV, the floor value and the multiplier M of the n-th portfolio are respectively 100, 90, and 4. The cushion value C % of the n-th portfolio is equal to (100−90)/100=10%. The value of X is equal to 40=4*10. The value of Y is equal to 60=1−40. Therefore, the portfolio asset allocation module 13 allocates 40% of the portfolio value CPV of the n-th portfolio to the second component, wherein and 60% of the portfolio value CPV of the n-th portfolio to the first component.

When one of the above-mentioned rebalancing conditions (a) to (d) contained in the rebalancing execution policy is satisfied, the steps 203 to 205 and/or the steps 201 and/or 202 are performed to “rebalance” the proportions of assets in the first and second components of the n-th portfolio. The latest caution value C %, the values of X % and Y % determined depending on the current portfolio value CPV of the n-th portfolio indicate thus the change of the proportions of the assets allocated in the components of the n-th portfolio.

It should be noted that the steps 201 and 202 of defining the floor value and/or the multiplier M of the n-th portfolio are preferably but not necessarily to be performed. The floor value and/or the multiplier M of the n-th portfolio may remain the same values or be redefined when one of the above-mentioned rebalancing conditions (a) to (d) contained in the rebalancing execution policy is satisfied, depending on the preference pre-specified by the participant.

In an advantageous embodiment, the asset allocation method comprises advantageously a set of steps 221 and 222 of allocating assets in at least one component of one of the N portfolios, such component comprising at least two sub-components with different risk levels. In an example, the first component of the n-th portfolio comprising a first sub-component and a second sub-component, wherein the risk level of the second sub-component is greater than that of the first sub-component.

The system manager 15 and/or the portfolio asset allocation module 13 are configured to calculate a component value of said first component obtained if one of the above-mentioned rebalancing conditions (a) to (d) selected to be included in the rebalancing execution policy is satisfied, and then perform the step 221 of allocating X % of the component value of said first component to the second sub-component, wherein X=M*C. The system manager 15 and/or the portfolio asset allocation module 13 are also configured to perform the step 222 of allocating Y % of the component value of said first component to the first sub-component, wherein Y=100−X.

In addition, it should also be noted that the division of a component of one of the N portfolios and the set of steps 221 and 222 are both optional and dependent from the execution of the above steps 201 to 205 of allocating assets in the components of one of the N portfolios. The division of a component of one of the N portfolios and the set of steps 221 and 222 are applied according to settings pre-defined by the participant. In addition, in an advantageous embodiment, the division of a component and the set of steps 221 and 222 are both performed recursively for a pre-determined number of times predefined by the participant. In other words, a component of one of the N portfolios is divided into two sub-components with different risk levels (as mentioned-above) so that the set of steps 221 and 222 are performed to allocate assets of the component to the two sub-components, then at least one of the two sub-components is divided into two component units with different risk levels so that that the set of steps 221 and 222 are performed to allocate assets of the sub-component to the two component units, and so forth.

In another example, the steps of 203 to 205 (and/or the steps 201, 202) of allocating assets in at least one of the N portfolios are triggered if the above condition (a) that the portfolio value CPV of the n-th portfolio is smaller than a predetermined minimum value such as 101% of the floor value is satisfied. That may mean that the portfolio value of the n-th portfolio is greatly reduced and the current portfolio value CPV of the n-th portfolio almost reaches the floor value.

The steps 201 and/or 202 of defining the floor value and/or the multiplier M can be, as previously mentioned, performed prior to the execution of the steps of 203 to 205.

The above steps 203 to 205 are performed to update the caution value C % of the n-th portfolio and the values X % and Y % indicating the new proportions of the assets to be allocated to the first and the second components of the n-th portfolio. In this case, the updated caution value C % is 1%. The values of X % and Y % are recalculated based on the updated caution value C %. The portfolio asset allocation module 13 thus moves at least partially, the assets of the second component to the first component of the n-th portfolio.

If the predetermined minimum value is predetermined to be almost equal to the floor value, the above steps 203 to 205 are performed to move almost entirely the assets of the second component to the first component of the n-th portfolio, so that the value of the first component is roughly equal to the portfolio value of the n-th portfolio. In some portfolio insurance strategies, being entirely invested in the safer component (e.g. the first component in the present embodiment) does not necessarily mean being locked into it at vitam eternam. Indeed, after the assets of the second component are moved to the first component of the n-th portfolio, the first component (the safer component) may generate a positive gain and the portfolio value of n-th portfolio may increase and be greater than the predetermined threshold value. The predetermined threshold value is preferably 105% of the floor value of the n-th portfolio.

In this case that portfolio value of n-th portfolio may have increased from the previous value which is not far from the floor value of the n-th portfolio, the above rebalancing condition (b) is satisfied. In one embodiment of the invention, the participant does not choose the above rebalancing condition (b) to be in his/her rebalancing execution policy so that none of the steps 201 to 205 is executed, and the assets of the n-th portfolio remain mostly or entirely locked in the first segment (the safer segment) of the n-th portfolio.

In another embodiment of the invention wherein when the above rebalancing condition (b) selected to be included in the participant's rebalancing execution policy is satisfied, the fact that the cushion value C % of the n-th portfolio recovers and the portfolio value CPV of the n-th portfolio is already increased to reach the predetermined threshold value enables, to reallocate a part of the n-th portfolio's assets previously allocated to the first component back to the second component (with a higher risk level) of the n-th portfolio. The set of steps of 203 to 205 (and/or the steps 201, 202) of allocating assets of the n-th portfolio is therefore triggered to update at least the caution value C %, and the values X % and Y % of the n-th portfolio.

In the example where the predetermined threshold value is 105% of the floor value of the n-th portfolio, the caution value C % of the n-th portfolio is 5%. The values of X % and Y % indicating new proportions of the assets allocated to the first and the second components of the n-th portfolio are recalculated based on the updated caution value C %. The portfolio asset allocation module 13 thus moves partially, the assets previously allocated in the first component to the second component of the n-th portfolio.

In a preferred but not limitative embodiment, the steps 201 and/or 202 of defining the floor value and/or the multiplier M can be, as previously mentioned, performed prior to the execution of the steps of 203 to 205.

In addition, due to the rapid change of the financial market, the n-th portfolio may suffer from a rapid, unexpected significant market downturn. The system manager 15 may possibly not be able to perform in time the set of steps 203 to 205 (and/or the steps 201, 202) of allocating assets in the n-th portfolio in order to rebalance the proportions of assets in the first and second components of the n-th portfolio to de-risk the n-th portfolio at the moment. The risk of breaching the floor value of the n-th portfolio, generally called “Gap Risk”, may thus rise.

Therefore, in an advantageous but not limitative embodiment, the asset allocation method comprises a step of gap compensation performed in the above situation where a gap risk may rise, a portfolio manager in charge of the saving program may decide to cover the gap risk with his own capital or using derivatives strategies, in order to ensure that the maximum loss level of the n-th portfolio is respected so that the participant will not suffer from unexpected dramatic asset loss.

The asset allocation method comprises an automatic gain allocation step performed at the end of the m-th inter-transfer period or the beginning of the (m+1)th inter-transfer period, wherein m is a positive integer greater than 1. At this moment, the system manager 15 is configured to calculate, at the end of the m-th inter-transfer period, a gain value of each of the N portfolios and send instructions comprising the calculated data to the capital distribution module 12. The gain of a n-th portfolio (n=1, 2, 3 . . . N) for the m-th inter-transfer period is obtained by performing the following equation:

gain=a final portfolio value−an initial portfolio value, wherein the final portfolio value and the initial portfolio value of assets of the n-th portfolio are respectively obtained at the end and the beginning of the m-th inter-transfer period.

If the gain of the n-th portfolio obtained at the end of the m-th inter-transfer period is greater than a first predetermined value, the system manager 15 and/or the capital distribution module 12 performs the automatic gain allocation step consisting of transferring said gain of the n-th portfolio to the (n−1)th or (n+1)th portfolio for the (m+1)th inter-transfer period. In other words, the automatic gain allocation step performs a chain transfer of gains respectively from the n-th portfolio having generated the gain to the adjacent riskier or safer portfolio (respectively the (n−1)th portfolio or (n+1)th portfolio). The first predetermined value is preferably equal to 0.

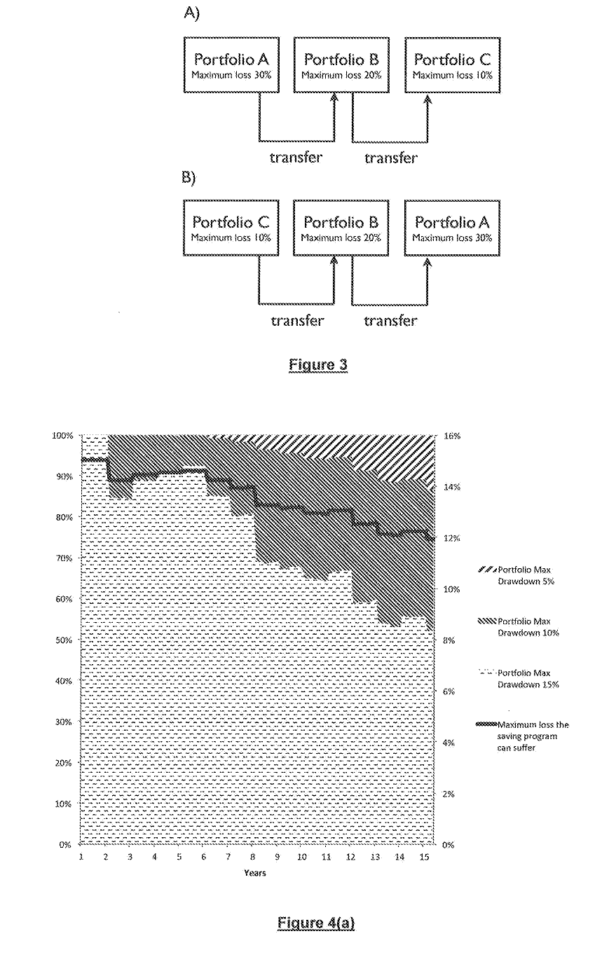

Selecting the direction of the chain transfer to an adjacent riskier or safer portfolio is predetermined by the participant. FIG. 3 illustrates two directions of the chain transfer according to the invention.

In an embodiment where the participant of the saving program predetermines that in the automatic gain allocation step, the positive gain generated in the m-th inter-transfer period is transferred from the n-th portfolio to the (n+1)th portfolio for the (m+1)th inter-transfer period. In this case, the gain of the N-th portfolio is remained in the N-th portfolio for the (m+1)th inter-transfer period, instead of being transferred to another one of the N portfolios.

One example Is given in FIG. 3(B), three portfolios A, B, and C of the saving program respectively presenting a maximum loss level equal to 10%, 20% and 30%. The gain of the portfolio C generated in the m-th inter-transfer period is transferred to the portfolio B for the (m+1)th inter-transfer period, and the gain of the portfolio B generated in the m-th inter-transfer period is transferred to the portfolio A for the (m+1)th inter-transfer period.

Therefore, at the beginning of the (m+1)th inter-transfer period, the initial portfolio value of the n-th portfolio comprises the gain transferred from the (n−1)th portfolio, the existing assets of the n-th portfolio, and at least a part of a new deposit if the participant assigns the at least a part of the new deposit to the n-th portfolio for the (m+1)th inter-transfer period according to the above-mentioned rule. Said initial portfolio value of the n-th portfolio does not comprise the gain that the n-th portfolio itself generates in the m-th inter-transfer period.

In a preferred but not limitative embodiment, the participant predetermines that in the automatic gain allocation step, the positive gain is transferred from the n-th portfolio to the (n−1)th portfolio for the (m+1)th inter-transfer period, so as to progressively de-risk the whole saving program with the passage of time. In this case, the gain of the first portfolio is remained in the first portfolio for the (m+1)th inter-transfer period, Instead of being transferred to another one of the N portfolios.

One example is given in FIG. 3(A), three portfolios A, B, and C of the saving program respectively presenting a maximum loss level equal to 30%, 20% and 10%. The gain of the portfolio C generated in the m-th inter-transfer period is transferred to the portfolio B for the (m+1)th inter-transfer period, and the gain of the portfolio B generated in the m-th inter-transfer period is transferred to the portfolio A for the (m+1)th inter-transfer period.

Therefore, at the beginning of the (m+1)th inter-transfer period, the initial portfolio value of the n-th portfolio comprises the gain transferred from the (n+1)th portfolio, the existing assets of the n-th portfolio, and at least a part of a new deposit if the participant assigns the at least a part of the new deposit to the n-th portfolio for the (m+1)th inter-transfer period according to the above-mentioned rule. Said initial portfolio value of the n-th portfolio does not comprise the gain that the n-th portfolio itself generates in the m-th inter-transfer period.

If the gain of the n-th portfolio obtained at the end of the m-th inter-transfer period is smaller than the first predetermined value, the assets in the n-th portfolio of the m-th inter-transfer period are remained in the n-th portfolio for the (m+1)th inter-transfer period.

Furthermore, in an embodiment where the saving program has a maturity date, the participant may wish to assign the first portfolio to a money market fund presenting a maximum loss level equal to 0%. The asset allocation method of the invention comprises further a transfer step consisting of transferring at least a part of assets in at least one of the portfolios of the saving program other than the first portfolio to the first portfolio before the participant effectively withdraws his/her previously invested assets from the saving program. The transfer step allows the participant to decide an amount of his assets of the saving program to be locked in the first portfolio preferably presenting no risk.

It should be noted that according to the invention, the N portfolios of the saving program can be adjusted by adding at least a new portfolio and/or deleting one of the N portfolios from saving program. In a case where a new portfolio is added into the saving program, the newly added portfolio presents preferably a maximum loss level different from that of any one of the N existing portfolios. The total number of the portfolios of the saving program is N+1. The system manager executes than the above-mentioned sorting rule to sort of the N+1 portfolios according to their respective maximum loss level, the N+1 sorted portfolios being then indexed by a positive integer number n, wherein n=1, 2, . . . N+1. In a case where a portfolio is deleted from the saving program, the total number of the portfolios of the saving program is N−1. The system manager 15 executes than the above-mentioned sorting rule to sort of the N−1 portfolios according to their respective maximum loss level, the N−1 sorted portfolios being then indexed by a positive integer number n, wherein n=1, 2, . . . N−1.

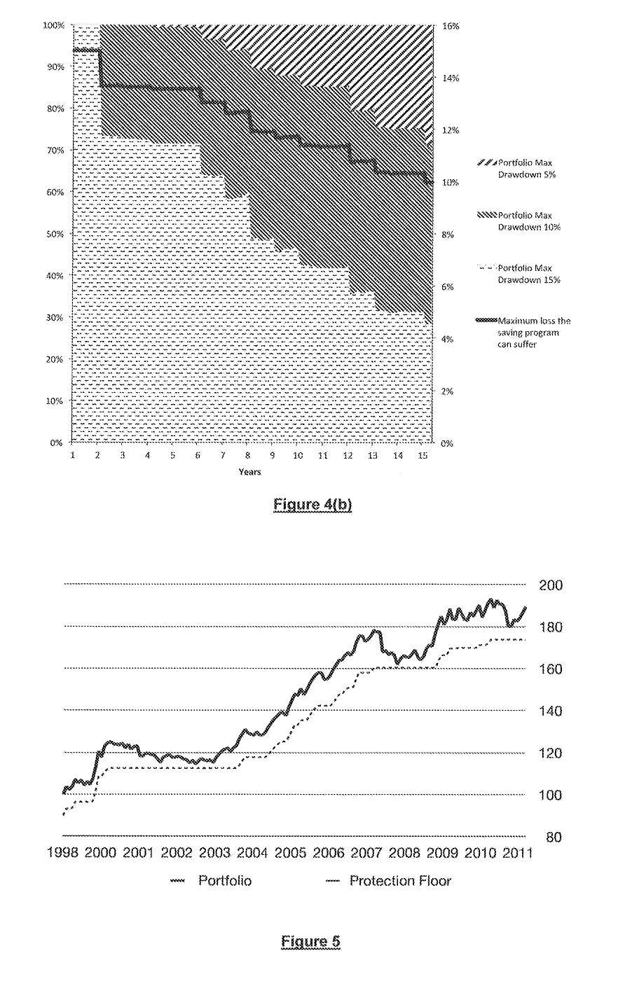

The aggregation module 14 is configured to retrieve the data generated by the system manager 15, the capital distribution module 12 and the portfolio asset allocation module 13, and the data stored in the data storage means 5, in order to generate the distribution of the participant's assets invested in the N portfolios of the saving program and send the data related to said distribution to the output device 16. Said data related to said distribution comprises at least the distribution of the assets invested in the N portfolios including the illustration of the proportions of assets allocated in each of the N portfolios (e.g. the weight that each portfolio represents in the overall saving program), and the maximum loss that the participant may suffer depending on his assets respectively allocated to the N portfolios, as illustrated in FIGS. 4(a) and 4(b) (which will be described in detail in the following paragraphs).

The output device 16 presents thus, preferably in a chart or graph format, the above-mentioned data related to the distribution of the participant's assets invested in the N portfolios of the saving program.

It should be noted that in the above embodiments, the rules of the asset allocation method is a computer program product stored in non-transitory computer-readable medium (such as the storage means 5) and comprising instructions adapted to perform the asset allocation method of the invention. However, in another embodiment of the invention, the system manager 15 and the asset allocation module 11 are two hardware devices with a computational computing capability respectively configured to execute the instructions/rules of the asset allocation method of the invention.

For ease of comprehension, an example with numbers is given as follows. Mrs. A. wishes to participate to a saving program as illustrated above according to present invention. The saving program of the present example comprises three portfolios including a “Secure” portfolio with a maximum loss level et equal to 10%, a “Moderate” portfolio with a maximum loss level at equal to 20%, and a “Risky” portfolio with a maximum loss level et equal to 30%.

The data storage means 5 of the asset allocation system 1 stores the participant's predefined variables such as the deposit allocation policy, the direction of the chain transfer and the length of the inter-transfer period. The length of the inter-transfer period is one year. One of the deposit allocation policy of Mrs. A is to deposit yearly $1,000 into the “Risky” portfolio. She chooses the direction of the chain transfer from a riskier portfolio to an adjacent safer portfolio.

At the beginning of Year 0, which is the first inter-transfer period, Mrs. A invests $1,000 in the “Risky” portfolio. At the end of the first inter-transfer period, the “Risky” portfolio yielded a 5% return, net of management fees and other costs involved in the portfolio management. The following table 1 summarizes the initial portfolio values and the final portfolio values of the three portfolios of the saving program of Mrs. A obtained at the beginning and the end of the first inter-transfer period:

TABLE 1

| | Initial portfolio value of | Final portfolio value of |
|---|---|---|
| | the first inter-transfer | the first inter-transfer |
| | period | period |
| Risky portfolio | $1,000 (100%) | $1,050 |
| Moderate portfolio | $0 (0%) | $0 |
| Secure portfolio | $0 (0%) | $0 |

The percentage shown within the parentheses indicates the proportion of each portfolio in the saving program.

At the beginning of Year 1 (the second inter-transfer period), according to the automatic gain allocation step of the invention, the gain generated over the first inter-transfer period in the “Risky” portfolio is $50 and is transferred into the “Moderate” portfolio. In addition, Mrs. A deposits $1,000 into the “Risky” portfolio.

At the end of the second inter-transfer period, the “Risky” portfolio yielded a −2% net return and the “Moderate” portfolio a 1% net return. No positive gain has been observed in the “Risky” portfolio, and therefore all the assets in the “Risky” portfolio are remained in the “Risky” portfolio. No asset Is transferred from the “Risky” portfolio to the “Moderate” portfolio. The “Moderate” portfolio generates a $0.5 gain during the second inter-transfer period. The following table 2 summarizes the initial portfolio values and the final portfolio values of the three portfolios obtained at the beginning and the end of the second inter-transfer period:

TABLE 2

| | Initial portfolio value | Final portfolio value of the |
|---|---|---|
| | of the second inter- | second inter-transfer |
| | transfer period | period |
| Risky portfolio | $2,000 (97.56%) = $1050 − | $1960 |
| | $50 + $1000 | |
| Moderate portfolio | $50 (2.44%) = $0 + $50 | $50.5 |
| Secure portfolio | $0 (0%) | $0 |

At the beginning of Year 2 (the third inter-transfer period), as mentioned previously, no asset is transferred from the “Risky” portfolio to the “Moderate” portfolio. The $0.5 gain generated in the “Moderate” portfolio during the second inter-transfer period is transferred to the next safer portfolio—the “Secure” portfolio. In addition, Mrs. A deposits $1,000 into the “Risky” portfolio.

At the end of the third inter-transfer period, the “Risky” portfolio yielded a 4% net return, the “Moderate” portfolio a 2% net return and the “Secure” portfolio a 1% net return. That means during the third inter-transfer period, Mrs. A's assets in the “Risky” portfolio generates a $118.4 capital gain, the “Moderate” portfolio generates a $1 gain and the “Secure” portfolio generates a $0.005 gain. The following table 3 summarizes the initial portfolio values and the final portfolio values of the three portfolios obtained at the beginning and the end of the third inter-transfer period:

TABLE 3

| | Initial portfolio value of the | Final portfolio value of |
|---|---|---|
| | third inter-transfer | the third inter-transfer |
| | period | period |
| Risky portfolio | $2,960 (98.32%) = $1960 + | $3078.4 |
| | $1000 | |
| Moderate portfolio | $50 (1.66%) = $50.5 − $0.5 | $51 |
| Secure portfolio | $0.5 (0.02%) = 0 + $0.5 | $0.5005 |

At the beginning of Year 3 (the fourth inter-transfer period), as mentioned previously, the $118.4 gain generated in the “Risky” portfolio during Year 2 is transferred to the “Moderate” portfolio, and the $1 gain generated in the “Moderate” portfolio during Year 2 is transferred to the “Secure” portfolio. The $0.005 gain of the “Secure” portfolio generated during Year 2 is remained in the “Secure” portfolio. In addition, Mrs. A deposits $1,000 again into the “Risky” portfolio. The following table 4 summarizes the initial portfolio values of the three portfolios obtained at the beginning of the fourth inter-transfer period,

TABLE 4

| | Initial portfolio value of the fourth inter- |
|---|---|
| | transfer period |
| Risky portfolio | $3,960 (95.89 %) = $3078.4 − $118.4 + |
| | $1000 |
| Moderate portfolio | $168.4 (4.08%) = $51 − $1 + $118.4 |
| Secure portfolio | $1.5005 (0.03%) = $0.5005 + $1 |

This process can last until Mrs. A decides to withdraw her capital entirely or partially or until a pre-determined target date.

The progressive change of the proportion of each portfolio in the saving program, as shown in the above four tables, indicates that the proportions of the less risky portfolios in terms of asset allocations tend to increase progressively. Such progressive change is in line with the general request from target-date portfolios investors that ask for better protection against losses in the years nearing retirement.

In addition, since each portfolio is explicitly designed to limit its maximum loss level to a given level, we can compute the overall expected maximum loss level of the program participant at any point in time. For instance:
In Year 0, Mrs. A's assets are fully invested in the “Risky” portfolio which presents a maximum loss level equal to 30%. Her overall expected maximum loss is therefore 30%.
In Year 1, 97.56% of Mrs. A's assets are invested in the “Risky” portfolio with a maximum lose level equal to 30%, and 2.44% of Mrs. A's assets are in the “Moderate” portfolio maximum loss level equal to 20%. Her overall expected maximum loss is now 97.56%*30%+2.44%*20%=29.76%

We first notice that it may be extremely relevant to a participant of the saving program to know at any point in time the maximum loss her portfolio(s) could suffer, which allows the participant or asset/portfolio manager to adjust her saving policy, to plan future expenses, to evaluate with more precision her income after retirement, etc.

Furthermore, as one of the consequence of the above-mentioned progressive change of the proportion of each portfolio, we observe that the overall maximum loss level of the participant's saving program progressively tends to decrease over time, from the maximum loss level of the riskiest portfolio to approach the maximum loss level of the safest portfolio. This is resulted from the execution of the automatic gain allocation step performed according to one pre-selected direction of the chain transfer of the gains: Excluding newly added deposits, the gain transfers will only occur from a riskier portfolio to a safer portfolio. This chain transfer typically accelerates as gains increase because of the compounding effect: we can observe this phenomenon in our example with the increasing $-value of gain transfers that occur between the “Moderate” and the “Secure” portfolio. It is an attractive feature for the saving program to explicitly protect its participant against a level of loss that decreases over time and to progressively lock-in the participant's gains. In addition, when the saving program is designed to stop at a pre-defined date, it is considered as a Target-Date Portfolio.

FIG. 4(a) is an example of the distribution of assets of the saving program with a yearly deposit allocated to the riskiest portfolio according to the invention. The saving program comprises three portfolios with different maximum loss levels; a first portfolio with a maximum drawdown of 5% (which means the maximum loss level of the first portfolio is 5%), a second portfolio with a maximum drawdown of 10% and a third one with a maximum drawdown of 15%. The duration of an inter-transfer period of the saving program is one year. The observation of the distribution lasts 15 inter-transfer periods (15 years).

The predefined deposit allocation policy of the participant is to deposit $1,000 every year into the third portfolio (as the riskiest portfolio) of the saving program. The direction of the chain transfer is from a riskier portfolio to an adjacent safer portfolio. The chart area (left scale) shows the evolution of the distribution of the participant's assets among the three portfolios of his saving program. Allocation to the safer portfolios increases over time.

The dark line (right scale) is the overall maximum loss level that the saving program can suffer. It starts from 15% (which is the maximum drawdown of the third portfolio) and decreases as time passes by. We observe that it is not monotonically decreasing because the regular yearly deposits allocated to the riskiest portfolio increase the relative weight of the riskiest portfolio in the saving program and thus the overall risk level of the saving program. Thus, as shown in FIG. 4(a), the distribution of the saving program indicates that the saving program could provide the participant with an incremental risk protection as his/her age increases.

FIG. 4(b) shows, on the other hand, an example of the distribution of assets of the saving program with only one single deposit allocated to the riskiest portfolio according to the invention. The rest of the settings of the saving program are identical to those of the above example illustrated in FIG. 4(a). In the example shown in FIG. 4(b), only one $1,000 initial lump sum is deposited in the saving program in the first year, no further deposits being allocated to the saving program in the following 14 years.

The overall maximum loss level of the saving program, shown as the dark line (right scale) of FIG. 4(b), starts also from 15% (which is the maximum drawdown of the third portfolio) and decreases as time passes by. Without taking into account the regular yearly deposits allocated to the riskiest portfolio (as the example of FIG. 4(a)), the dark line of FIG. 4(b) illustrates more clearly that the overall risk level of the saving program decreases monotonically because of the chain transfer of gains performed by executing the automatic chain allocation step of the invention. Thus, as shown in FIG. 4(b), the distribution of the saving program indicates that the saving program could provide the participant with an incremental risk protection as his/her age increases.

FIG. 5 is an example of the evolution of the portfolio value of a portfolio of the saving program protected by a floor value according to the invention. The floor value is configured to limit the portfolio's maximum drawdown to 10%.

The invention, especially with the direction of the chain transfer from a riskier portfolio to an adjacent safer portfolio, provides therefore an incremental downside risk protection for the invested assets of the saving program, which can be detailed as follows:
For each of the N portfolios of the saving program, the portfolio value of the portfolio does not fall under the floor value of said portfolio, that limits the maximum losses of assets allocated in the portfolio to a specific level acceptable for the participant.
The participant's assets in the overall saving program do not suffer a loss greater than the maximum loss level chosen for the riskiest portfolio (which is the N-th portfolio).
The percentage of maximum loss of the assets that have already been deposited in the saving program decreases with time. It is in line with the expectation of a retirement saving programs' participants as they approach the date of their retirement.
The gains generated during the life of the saving program are progressively locked-in by being transferred from the portfolios which generates the gains to safer portfolios.
At any point in time, the participant knows the maximum degree of loss of his assets may occur.
Contrary to deterministic glidepath programs, the saving program of the invention presents a significant reactivity to market conditions. For each portfolio of the saving program, the exposure of a portfolio to risky assets increases or decreases depending on the cushion value of the portfolio. It allows thus the participant to grow his assets in market rallies and to protect his assets from market downturns.
Contrary to deterministic glidepath programs, the present invention allows the participant to keep his/her assets being partially exposed to a higher risk, in a risk-controlled way, so as to possibly generate more gains. Meanwhile, the invention allows the participant to increase his assets with a reduced level of maximum loss.
Contrary to Target Date funds that are designed to run until a given maturity date, the saving program according to the present invention does not necessarily need a maturity date. The saving program according to the invention can thus keep functioning and growing the participant's assets as long as the participant requires it. This feature is relevant when considering the uncertainties about the retirement age in some countries such as the United Kingdom. In the United Kingdom, from the year 2015, retirees will no longer be obliged to convert their retirement savings into an annuity contract with an insurance company. The UK retirees may wish to participate the saving program according to the invention in order to keep at least a part of their savings being invested in riskier portfolios to generate gains in a risk-controlled way.
By shifting gains among different risk-controlled portfolios, the present invention aims not only at introducing certainty to the DC plan participants' future wealth but also at being extended/applied to other investment plans.

The steps and rules of the computer-implemented method of the invention and advantages as described above indicate that the method of the invention presents a low complexity and a high efficiency, which allows to automatically determiner and generate, almost immediately, an optimal asset distribution for each of thousands (or even more) of participants of the saving program. In a case that the markets are severely and/or unexpectedly down, the above set of steps allocating assets (steps 203 to 205 and/or steps 201, 202 for instance) needs to be immediately triggered and the result needs to be obtained immediately in order to react to the market change in time to avoid a further investment loss. Such rebalancing efficiency relies significantly on the computational efficiency of the method and system of the invention as well as the computer elements utilized for implementing the method and system of the invention.

The present invention is therefore able to provide, during the life of the saving program, an automatic allocation of assets of the portfolios of the saving program, which provides a great flexibility and reactivity to different market conditions, and an adjustable downside risk protection for the invested assets of the saving program.

While certain features of the described implementations have been Illustrated as described herein, many modifications, substitutions, changes and equivalents will now occur to those skilled in the art. It is, therefore, to be understood that the appended claims are intended to cover all such modifications and changes as fall within the true spirit and the scope of the embodiments of the invention.

We claim:

1. A computer-implemented asset allocation method configured to allocate assets of at least one participant to a saving program comprising N portfolios, the life of the saving program comprising T inter-transfer periods, T being a positive integer, each of the N portfolios comprising assets presenting a portfolio value and a maximum loss level, the latter being configured to indicate the maximum possible percentage that the portfolio value may lose; the asset allocation method comprising the following steps:
a step of sorting the N portfolios according to their respective maximum loss level, the N sorted portfolios being indexed by a positive integer n between 1 and N, so as to indicate that a first portfolio, with n being 1, presents the smallest maximum loss level among the N portfolios, and the maximum loss level of a n-th portfolio among the N portfolios is not smaller than the maximum loss level of a (n−1)^{th} portfolio when n is between 2 and N, and,
a step of calculating a gain for each of the N portfolios at the end of a (m−1)th inter-transfer period, wherein m is a positive integer between 2 and T, said gain of a n-th portfolio is equal to a final portfolio value minus an initial portfolio value, wherein the final portfolio value of assets of the n-th portfolio is obtained at the end of the (m−1)th inter-transfer period, and the initial portfolio value of assets in the n-th portfolio is obtained at the beginning of the (m−1)th inter-transfer period,
an automatic gain allocation step consisting of, for each of the N portfolios, transferring the gain of the n-th portfolio obtained at the end of the (m−1)th inter-transfer period to:
the (n−1)th portfolio for the m-th inter-transfer period if said gain is greater than a first predetermined value, wherein the gain of the first portfolio for the (m−1)th inter-transfer period is remained in the first portfolio for the m-th inter-transfer period, or
the (n+1)th portfolio for the m-th inter-transfer period if said gain is greater than the first predetermined value, wherein the gain of the N-th portfolio for the (m−1)th inter-transfer period is remained in the N-th portfolio for the m-th inter-transfer period,
so that the initial portfolio value of the (n−1)th or (n+1)th portfolio obtained at the beginning of the m-th inter-transfer period comprises said gain of the n-th portfolio.

2. The computer-implemented asset allocation method of claim 1, comprising a set of steps of allocating assets in the n-th portfolio, the n-th portfolio comprising at least two components comprising a first component and a second component, wherein the risk level of the second component is greater than that of the first component, the set of steps of allocating assets comprising:
calculating, for the n-th portfolio, a cushion value C % is equal to a ratio between a first difference value and a current portfolio value CPV, wherein the first difference value is equal to the current portfolio value CPV of the n-th portfolio minus a floor value of the n-th portfolio,
allocating X % of the current portfolio value CPV of the n-th portfolio to the second component, wherein X is equal to a multiplier M multiplied by C,
allocating Y % of the current portfolio value CPV of the n-th portfolio to the first component, wherein Y is equal to 100 minus X,
wherein a floor value of the n-th portfolio is configured to indicate that the portfolio value CPV of the n-th portfolio obtained at any time point needs to be not smaller than the floor value, and the multiplier M of the n-th portfolio is a coefficient configured to adjust the sensibility of the n-th portfolio to market changes.

3. The computer-implemented asset allocation method of claim 2, wherein the set of steps of allocating assets comprising, prior to the step of calculating the cushion value C % of the n-th portfolio, a step of defining the floor value and/or a step of defining the multiplier M.

4. The computer-implemented asset allocation method of claim 3, wherein the set of steps of allocating assets in the n-th portfolio are triggered if one of the following rebalancing conditions (a) to (d) is satisfied:
(a) the portfolio value CPV of the n-th portfolio is smaller than a corresponding predetermined minimum value;
(b) the portfolio value CPV of the n-th portfolio is greater than a corresponding threshold value;
(c) the relative proportion between the assets allocated in the first and second components of the n-th portfolio deviates from a previously determined target proportion more than a pre-specified level determined as a function of the target proportion;
(d) periodical rebalancing, performed according to a rebalancing frequency pre-defined by the participant.

5. The computer-implemented asset allocation method of claim 4, wherein the predetermined minimum value is determined as a function of the floor value of the n-th portfolio.

6. The computer-implemented asset allocation method of claim 5, wherein the predetermined minimum value is 101% of the floor value.

7. The computer-implemented asset allocation method of claim 4, wherein the predetermined threshold value is determined as a function of the floor value of the n-th portfolio.

8. The computer-implemented asset allocation method of claim 7, wherein the predetermined threshold value is 105% of the floor value.

9. The computer-implemented asset allocation method of claim 2, comprising further a set of steps of allocating assets in at least one component of the first and second components of the n-th portfolio, the component comprising at least two sub-components comprising a first sub-component and a second sub-component, wherein the risk level of the second sub-component is greater than that of the first sub-component, the set of steps of allocating assets in the component comprising:
allocating X % of the component value of the component to the second sub-component, wherein the component value is obtained at a time point of the m-th inter-transfer period,
allocating Y % of said component value.

10. The computer-implemented asset allocation method of the claim 9, wherein the set of steps of allocating assets in at least one component is performed recursively.

11. The computer-implemented asset allocation method of claim 1, wherein if the gain of the n-th portfolio obtained at the end of the (m−1)th inter-transfer period is not greater than the first predetermined value, assets in the n-th portfolio will be remained for the m-th inter-transfer period.

12. The computer-implemented asset allocation method of claim 1, comprising a step of allocating a new deposit to the saving program for the m-th inter-transfer period while m is equal to or greater than 1, configured so that the initial portfolio value of at least one of the N portfolios obtained at the beginning of the m-th inter-transfer period comprises at least a part of said new deposit.

13. The computer-implemented asset allocation method of claim 1, comprising further at least one of the following deposit allocation rules (a) to (e) performed to allocate a new deposit to at least one of the N portfolios for the m-th inter-transfer period:
(a) the new deposit is entirely allocated to a pre-selected portfolio of the saving program for the m-th inter-transfer period;
(b) the new deposit is equally allocated to the N portfolios for the m-th inter-transfer period;
(c) the new deposit is equally allocated to a plurality of pre-selected portfolios among the N portfolios for the m-th inter-transfer period;
(d) the new deposit is non-equally allocated to the N portfolios for the m-th inter-transfer period;
(e) the new deposit is non-equally allocated to a plurality of pre-selected portfolios among the N portfolios for the m-th inter-transfer period, wherein the plurality of pre-selected portfolios is chosen by the participant as well as the amounts of capital received by the pre-selected portfolios are pre-defined by the participant.

14. The computer-implemented asset allocation method of claim 13, wherein at least one of the pre-selected portfolio, the plurality of pre-selected portfolios, the amounts of capital received by the plurality of pre-selected portfolios of the deposit allocation rule (e), the proportions of capital received by the N portfolios of the deposit allocation rule (d) is pre-defined by the participant.

15. The computer-implemented asset allocation method of claim 14, wherein the pre-selected portfolio is determined as a function of time.

16. The computer-implemented asset allocation method of claim 1, wherein any two of the N portfolios present a different maximum loss level.

17. The computer-implemented asset allocation method of claim 1, wherein the first portfolio presents a smallest maximum loss level equal to 0%.

18. The computer-implemented asset allocation method of claim 17, comprising a step of transferring at least a part of assets in at least one of the portfolios of the saving program other than the first portfolio to the first portfolio with a maximum loss level equal to 0%.

19. A computer program product stored in non-transitory computer-readable medium and comprising instructions adapted to perform the computer-implemented asset allocation method of claim 1.

20. An asset allocation system comprising a computerized system comprising:
a non-transitory computer-readable medium configured to store at least (a) a computer program configured to allocate assets of at least one participant to a saving program comprising N portfolios, the life of the saving program comprising T inter-transfer periods, T being a positive integer, and (b) data of each of the N portfolios, for each of the T inter-transfer periods, comprising assets presenting a portfolio value and a maximum loss level, the latter being configured to indicate the maximum possible percentage that the portfolio value may lose,
a processor configured to execute, in accordance with the computer program stored in the non-transitory computer-readable medium, instructions for:
sorting the N portfolios according to their respective maximum loss level, the N sorted portfolios being indexed by a positive integer n between 1 and N, so as to indicate that a first portfolio, with n being 1, presents the smallest maximum loss level among the N portfolios, and the maximum loss level of a n-th portfolio among the N portfolios is not smaller than the maximum loss level of a (n−1)th portfolio when n is between 2 and N, and,
calculating a gain for each of the N portfolios at the end of a (m−1)th inter-transfer period, wherein m is a positive integer between 2 and T, said gain of a n-th portfolio is equal to a final portfolio value minus an initial portfolio value, wherein the final portfolio value of assets of the n-th portfolio is obtained at the end of the (m−1)th inter-transfer period, and the initial portfolio value of assets in the n-th portfolio is obtained at the beginning of the (m−1)th inter-transfer period,
performing an automatic gain allocation step consisting of, for each of the N portfolios, transferring the gain of the n-th portfolio obtained at the end of the (m−1)th inter-transfer period to:
the (n−1)th portfolio for the m-th inter-transfer period if said gain is greater than a first predetermined value, wherein the gain of the first portfolio for the (m−1)th inter-transfer period is remained in the first portfolio for the m-th inter-transfer period, or
the (n+1)th portfolio for the m-th inter-transfer period if said gain is greater than the first predetermined value, wherein the gain of the N-th portfolio for the (m−1)th inter-transfer period is remained in the N-th portfolio for the m-th inter-transfer period,
so that the initial portfolio value of the (n−1)th or (n+1)th portfolio obtained at the beginning of the m-th inter-transfer period comprises said gain of the n-th portfolio.
